(19) United States
(12) Patent Application Publication
(10) Pub. No.: US 2021/0107488 A1
(43) Pub. Date: Apr. 15, 2021

(54) ELECTRONIC DEVICE AND OPERATING METHOD THEREOF

(71) Applicant: SAMSUNG ELECTRONICS CO., LTD., Suwon-si (KR)

(72) Inventor: Wonguk JEONG, Suwon-si (KR)

(73) Assignee: SAMSUNG ELECTRONICS CO., LTD., Suwon-si (KR)

(21) Appl. No.: 17/050,274

(22) PCT Filed: Apr. 16, 2019
(86) PCT No.: PCT/KR2019/004566

§ 371 Date: Oct. 23, 2020

(30) Foreign Application Priority Data
Apr. 27, 2018 (KR) 10-2018-0049096

(51) Int. Cl. B60W 40/04; G08G 1/16; G06N 20/00; B60W 40/10

(52) U.S. Cl. CPC B60W 40/04; B60W 40/10; G06N 20/00; G08G 1/167

(57) ABSTRACT

Provided are an electronic device and an operating method thereof. The electronic device for assisting driving of a vehicle may include one or more sensors, a memory storing one or more instructions, and a processor configured to execute the one or more instructions stored in the memory, wherein the processor is configured to execute the one or more instructions to determine a current driving state of the vehicle by using the one or more sensors during the driving of the vehicle, based on the determined current driving state, to dynamically adjust a sensing sensitivity of at least one sensor related to a driving-assistance operation, from among the one or more sensors, and to control the driving-assistance operation of the vehicle by using the at least one sensor related to the driving-assistance operation.

In addition, the disclosure relates to an artificial intelligence (AI) system utilizing a machine learning algorithm such as deep learning, and an application thereof.

### TECHNICAL FIELD

The present disclosure relates to an electronic device and an operating method of the electronic device, and more particularly, to an electronic device for assisting driving of a vehicle, and an operating method thereof.

In addition, the present disclosure relates to an artificial intelligence (AI) system utilizing a machine learning algorithm such as deep learning, and an application thereof.

### BACKGROUND ART

An artificial Intelligence (AI) system is a computer system that implements human-level intelligence, and is, unlike existing rule-based smart systems, a system in which a machine trains itself, performs determination, and becomes more intelligent. As the AI system is used, the recognition rate thereof is improved and user's preferences may be understood more accurately, and thus, the existing rule-based smart system has been gradually replaced by a deep learning-based AI system.

AI technology includes machine learning (deep learning), and elemental technologies that utilize machine learning.

Machine learning is an algorithm technology that classifies/learns the characteristics of input data by itself, and element technology is a technology that utilizes a machine learning algorithm such as deep learning. The element technology includes technical fields such as linguistic understanding, visual understanding, reasoning/prediction, knowledge expression, motion control, and the like.

Various fields to which the AI technology is applied are as follows. Linguistic understanding is a technology that recognizes and applies/processes human language/characters, and includes natural language processing, machine translation, conversation system, query and answer, speech recognition/synthesis, and the like. Visual understanding is a technology that recognizes and processes objects as human vision, and includes object recognition, object tracking, image search, human recognition, scene understanding, spatial understanding, and image improvement. Reasoning and prediction is a technology for logically reasoning and predicting information by determining information, and includes knowledge/probability-based reasoning, optimization prediction, preference-based planning, recommendation, and the like. Knowledge representation is a technology that automatically processes human experience information into knowledge data, and includes knowledge building (data generation/classification), knowledge management (data utilization), and the like. Motion control is a technology for controlling autonomous driving of a vehicle and movement of a robot, and includes motion control (navigation, collision, driving), operation control (behavior control), and the like.

### DESCRIPTION OF EMBODIMENTS

### Technical Problem

Provided are an electronic device and operating method of assisting driving of a vehicle. In addition, provided is a computer-readable recording medium having recorded thereon a program for executing the method on a computer. The technical problem to be solved is not limited to the technical problems as described above, and other technical problems may exist.

### Solution to Problem

According to an aspect of the disclosure, an electronic device for assisting driving of a vehicle may include one or more sensors, a memory storing one or more instructions, and a processor configured to execute the one or more instructions stored in the memory, wherein the processor is configured, by executing the one or more instructions, to determine a current driving state of the vehicle by using the one or more sensors during the driving of the vehicle, based on the determined current driving state, to dynamically adjust a sensing sensitivity of at least one sensor related to a driving-assistance operation, from among the one or more sensors, and to control the driving-assistance operation of the vehicle by using the at least one sensor related to the driving-assistance operation.

According to another aspect of the disclosure, an operating method of an electronic device for assisting driving of a vehicle may include determining a current driving state of the vehicle by using one or more sensors during the driving of the vehicle, dynamically adjusting, based on the determined current driving state, a sensing sensitivity of at least one sensor related to a driving-assistance operation, from among the one or more sensors, and controlling the driving-assistance operation of the vehicle by using the at least one sensor related to the driving-assistance operation.

According to another aspect of the disclosure, a computer-readable recording medium includes a recording medium having recorded thereon a program for executing the operating method on a computer.

### BRIEF DESCRIPTION OF DRAWINGS

FIG. 1 is a diagram illustrating an example in which an electronic device assisting driving of a vehicle operates according to an embodiment.

FIG. 2 is a flowchart of an operating method of an electronic device according to an embodiment.

FIG. 3 is a flowchart of an operating method of an electronic device according to an external situation of a vehicle according to an embodiment.

FIG. 4 is a diagram for describing an operating method of an electronic device according to an external situation of a vehicle according to an embodiment.

FIG. 5 is a flowchart of an operating method of an electronic device according to an external situation of a vehicle according to another embodiment.

FIG. 6 is a diagram for describing an example of the sensing sensitivity of a sensor according to an embodiment.

FIG. 7 is a flowchart of an operating method of an electronic device according to a driver's state according to an embodiment.

FIG. 8 is a diagram for describing an operating method of an electronic device according to a drivers state according to an embodiment.

FIG. 9 is a diagram for describing an example of adjusting the sensing sensitivity of a sensor by using a trained model according to an embodiment.

FIG. 10 is a block diagram of an electronic device according to an embodiment.

FIG. 11 is a block diagram of an electronic device according to another embodiment.

FIG. 12 is a block diagram of a vehicle according to an embodiment.

FIG. 13 is a block diagram of a processor according to an embodiment.

FIG. 14 is a block diagram of a data training unit according to an embodiment.

FIG. 15 is a block diagram of a data recognition unit according to an embodiment.

FIG. 16 is a diagram illustrating an example of training and recognizing data by interworking between an electronic device and a server according to an embodiment.

### MODE OF DISCLOSURE

Hereinafter, embodiments of the disclosure will be described in detail with reference to the accompanying drawings so that one of skill in the art to which the disclosure pertains can easily implement them. However, the disclosure may be implemented in various different forms and is not limited to the embodiments described herein. In addition, in order to clearly describe the disclosure in the drawings, parts irrelevant to the description are omitted, and like reference numerals are assigned to similar parts throughout the specification.

Terms used in the disclosure have been described as general terms that are currently used in consideration of the functions mentioned in the disclosure, but may mean various other terms according to intentions of a person of skill in the art or precedents or the appearance of new technologies. Therefore, the terms used in the disclosure should not be interpreted only by the name of the terms, but should be interpreted based on the meaning of the terms and contents throughout the disclosure.

In addition, terms such as first and second may be used to describe various components, but the components should not be limited by these terms. These terms are used to distinguish one component from other components.

In addition, the terms used in the disclosure are only used to describe specific embodiments, and are not intended to limit the disclosure. Singular expressions include plural meanings unless the context clearly refers to the singular. In addition, throughout the specification, when a part is referred to as being “connected to” another part, it can be “directly connected” with the other part or it can be “electrically connected” with the other part by having an intervening element therebetween. In addition, when a part is described to “include” a certain component, this means that other components may be further included rather than excluding other components, unless otherwise specified.

In the specification, in particular, the article “the” and similar directives used in the claims may indicate both singular and plural. In addition, unless there is a clear description of the order of steps describing a method according to the disclosure, the steps described may be performed in an appropriate order. The disclosure is not limited in the order of description of the described steps.

The phrases “in some embodiments” or “in an embodiment” appearing in various places in the specification are not necessarily all referring to the same embodiment.

Some embodiments of the disclosure may be represented by functional block configurations and various processing steps. Some or all of these functional blocks may be implemented with various numbers of hardware and/or software configurations that perform particular functions. For example, the functional blocks of the disclosure can be implemented by one or more microprocessors, or by circuit configurations for a given function. Further, for example, functional blocks of the disclosure may be implemented in various programming or scripting languages. The functional blocks may be implemented with algorithms executed on one or more processors. In addition, the disclosure may employ related-art techniques for electronic environment setting, signal processing, and/or data processing. Terms such as “mechanism”, “element”, “means” and “configuration” can be used broadly, and are not limited to mechanical and physical configurations.

In addition, the connection lines or connection members between the components shown in the drawings are merely illustrative of functional connections and/or physical or circuit connections. In an actual device, connections between components may be represented by various functional connections, physical connections, or circuit connections that are replaceable or added.

Hereinafter, the disclosure will be described in detail with reference to the accompanying drawings.

In the specification, a vehicle 1 may include an electronic device 100 configured to assist or autonomously control driving of the vehicle 1 (hereinafter, referred to as the electronic device 100).

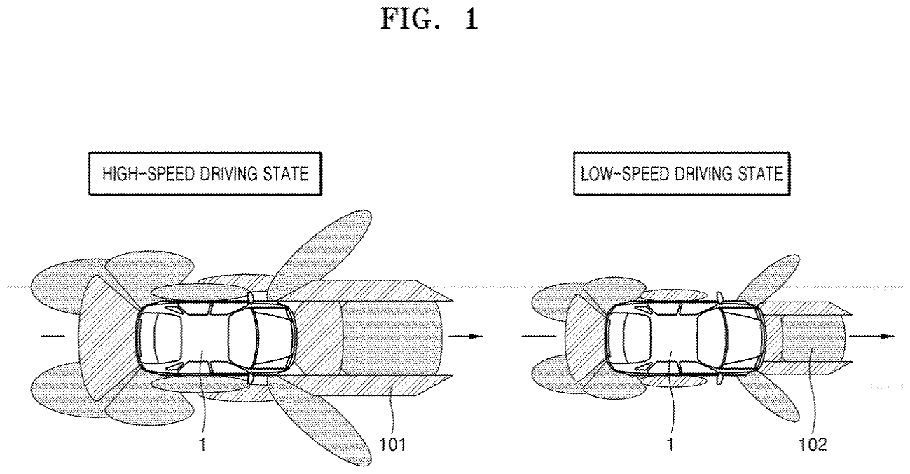

FIG. 1 is a diagram illustrating an example in which an electronic device operates according to an embodiment.

According to an embodiment, the electronic device 100 may determine the current driving state of the vehicle 1 during the driving of the vehicle 1, and dynamically adjust the sensing sensitivity of various sensors mounted on the vehicle to be most appropriate for safe driving in the current driving state.

For example, when it is determined that the vehicle 1 is currently traveling at a high speed and the surroundings are dark night time, the electronic device 100 may increase the sensing sensitivity of various sensors such as a distance sensor and a pedestrian recognition sensor that are mounted on the vehicle. Further, the electronic device 100 may continuously determine the driving condition of the vehicle 1, and when the vehicle 1 is determined to be in a stopped state, the electronic device 100 may reduce the sensing sensitivity of the distance sensor or the like.

As illustrated in FIG. 1, sensing sensitivity 101 of a sensor may be increased in a high-risk situation such as high-speed driving, and sensing sensitivity 102 of the sensor may be decreased in a low-risk situation such as low-speed driving.

For example, by increasing the sensing sensitivity of a distance sensor and the like, it is possible to detect an object, obstacle, road condition, and the like, at a longer distance and control a safer driving-assistance operation.

In addition, for example, as the sensing sensitivity of the distance sensor and the like is increased, the electronic device 100 may notify a user of a distance between the vehicle and a vehicle farther away in front.

In addition, for example, by increasing the sensing sensitivity of a proximity sensor or the like, it is possible to generate a warning sound or perform sudden stop motion control even when detecting an obstacle existing within a wider measurement range from the vehicle 1.

Accordingly, when the electronic device 100 assists or autonomously controls the driving of the vehicle 1, the risk of accident of the vehicle 1 may be lowered and safer driving may be possible.

In addition, according to an embodiment, the electronic device 100 may dynamically adjust a sensing sensitivity of various sensors mounted on the vehicle 1 to be most appropriate for safe driving based on the current external situation of the vehicle, for example, weather conditions, road conditions, and the like.

In addition, according to an embodiment, the electronic device 100 may dynamically adjust the sensing sensitivity of various sensors mounted on the vehicle 1 to be most appropriate for safe driving based on the current state of the driver of the vehicle, for example, a drowsiness state, a reaction speed during driving control, and the like.

According to an embodiment, the electronic device 100 may dynamically adjust the sensing sensitivity of at least one sensor related to a driving-assistance operation based on at least one of a vehicle's current driving state, an external situation, and/or a driver's state.

In addition, according to an embodiment, the electronic device 100 may determine, by using a data recognition model trained by using an artificial intelligence algorithm, sensing sensitivity values of various sensors mounted on the vehicle based on at least one of a vehicle's current driving state, an external situation, and/or a drivers state. The electronic device 100 may dynamically adjust a sensing sensitivity for a combination of at least one sensor that requires sensing sensitivity adjustment.

According to an embodiment, a processor 120 of the electronic device 100 may predict a dangerous situation more accurately and prevent a dangerous situation by dynamically adjusting the sensing sensitivity of sensors included in the vehicle 1. The electronic device 100 may provide a safer driving environment to the driver by providing a notification to the driver or directly controlling a driving operation of the vehicle 1.

FIG. 1 merely illustrates an embodiment, and is not limited thereto.

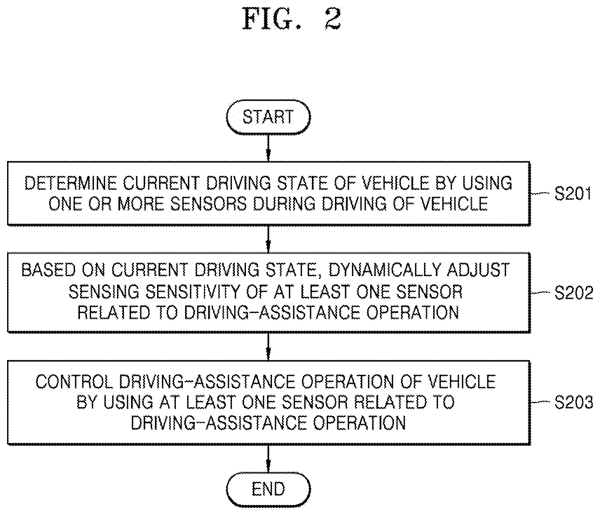

FIG. 2 is a flowchart of an operating method of an electronic device according to an embodiment.

In operation S201 of FIG. 2, the electronic device 100 may determine a current driving state of the vehicle by using one or more sensors during the driving of the vehicle.

According to an embodiment, the electronic device 100 may use one or more sensors to determine the current driving state of the vehicle, for example, high-speed driving, low-speed driving, parking, rapid acceleration, sudden stop, braking distance, collision, and the like, but it is not limited thereto.

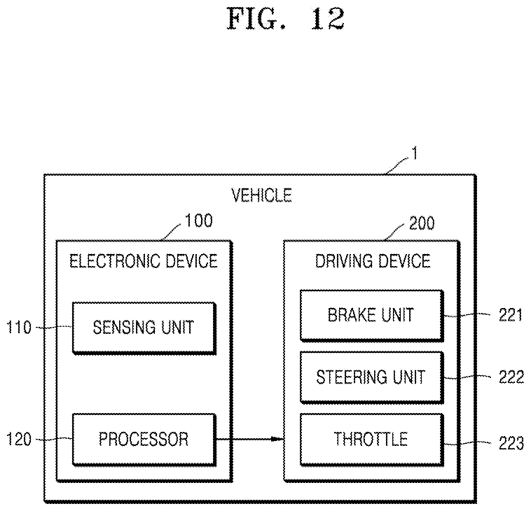

According to an embodiment, the electronic device 100 may include at least one of a global positioning system (GPS) 224 (see FIG. 12), an inertial measurement unit (IMU) 225 (see FIG. 12), a radar sensor 226 (see FIG. 12), a Light Detection And Ranging (LIDAR) sensor 227 (see FIG. 12), an image sensor 228 (see FIG. 12), an odometry sensor 230 (see FIG. 12), a temperature/humidity sensor 232 (see FIG. 12), an infrared sensor 233 (see FIG. 12), a barometric pressure sensor 235 (see FIG. 12), a proximity sensor 236 (FIG. 12), an RGB sensor (illuminance sensor) 237 (see FIG. 12), a magnetic sensor 229 (see FIG. 12), an acceleration sensor 231 (see FIG. 12), or a gyroscope sensor 234 (see FIG. 12), but is not limited thereto.

According to an embodiment, a sensing unit 110 including an acceleration sensor 231, the gyroscope sensor 234, the IMU 225, and the like, may detect the driving speed, driving acceleration, driving direction, and the like of a vehicle 1.

In operation S202 of FIG. 2, the electronic device 100 may dynamically adjust the sensing sensitivity of at least one sensor related to a driving-assistance operation based on a current driving state.

According to an embodiment, the electronic device 100 may adjust the sensing sensitivity of at least one sensor related to a driving-assistance operation based on the risk of the current driving state. For example, in a high-risk situation such as high-speed driving, the sensing sensitivity of a sensor may be increased. In addition, when the speed of the vehicle 1 decreases and the electronic device 100 becomes a low-speed driving state, the electronic device 100 may reduce the sensing sensitivity of a sensor.

In operation S203 of FIG. 2, the electronic device 100 may control the driving-assistance operation of the vehicle by using at least one sensor related to a driving-assistance operation.

According to an embodiment, the electronic device 100 may enable more precise sensing of data required for driving control of the vehicle 1 by using at least one sensor whose sensing sensitivity is dynamically adjusted to be appropriate for the current driving state of the vehicle 1. Accordingly, safer driving-assistance or autonomous driving control can be implemented.

In addition, according to an embodiment, when a dangerous situation (for example, when a distance to a vehicle in front is close or in case of a danger of collision with a pedestrian) is detected by using at least one sensor related to a driving-assistance operation, the electronic device 100 may generate a notification or a warning sound to the driver.

FIG. 2 illustrates an embodiment and is not limited thereto.

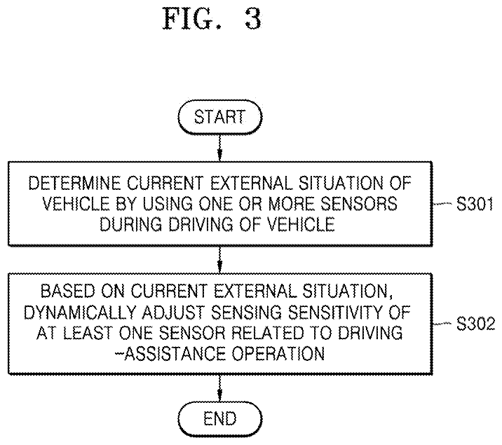

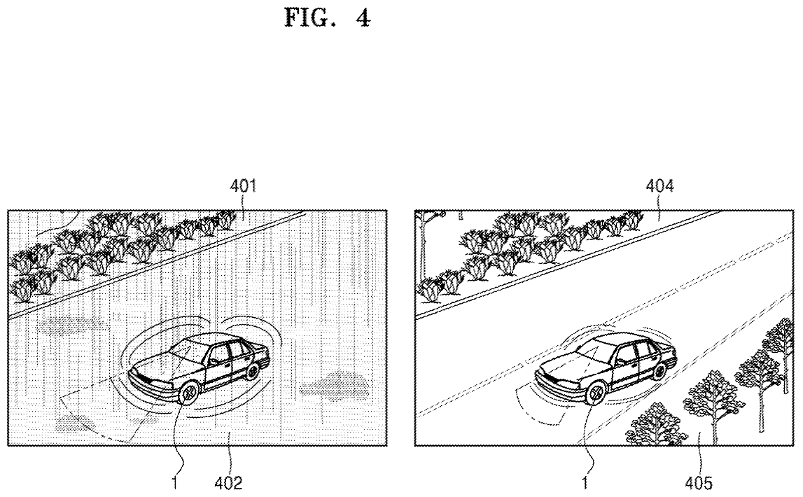

FIG. 3 is a flowchart of an operating method of an electronic device according to an external situation of a vehicle according to an embodiment. FIG. 4 is a diagram for describing an operating method of an electronic device according to an external situation of a vehicle according to an embodiment. The flowchart of FIG. 3 will be described with reference to FIG. 4.

In operation S301 of FIG. 3, the electronic device 100 may determine a current external situation of a vehicle by using one or more sensors during the driving of the vehicle. In operation S302 of FIG. 3, the electronic device 100 may dynamically adjust sensing sensitivity of at least one sensor related to a driving-assistance operation based on a current external situation.

According to an embodiment, an external situation of the vehicle may include weather, ambient illuminance, a state of other vehicles around the vehicle, road conditions, and the like.

The sensing unit 110 of the electronic device 100 according to an embodiment may detect weather (e.g., whether it is difficult to secure a forward view due to snow, rain, fog, and the like), road surface condition (freeze of the road surface, whether the road surface is slippery, and the like), and road condition (for example, whether it is a section under construction, whether it is a section in which the road is narrowed to a single lane, whether it is a one-way section, whether it is an accidental section, and the like). In addition, the sensing unit 110 may detect a pedestrian or an obstacle on the driving path.

For example, the electronic device 100 may determine whether it is currently raining by using a rain detection sensor included in the vehicle 1.

Further, according to an embodiment, the sensing unit 110 including the RADAR sensor 226, the LIDAR sensor 227, the image sensor 228, and the like, may detect other vehicles around the vehicle 1, a road shape, and the like. For example, the LIDAR sensor 227 may output a laser beam by using a laser output device, and to obtain a reflected signal from an object through at least one laser reception device, thereby detecting the shape of a surrounding object, the distance from the surrounding object, and terrain around the surrounding object.

In addition, according to an embodiment, the driving state of other vehicles around the vehicle may include driving speeds, driving acceleration, driving direction, intention to change directions, driving patterns such as sudden stop, rapid acceleration, and the like of other vehicles.

In addition, the sensing unit 110 of the electronic device 100 according to an embodiment may obtain an image of another vehicle driving around the vehicle. The processor 120 according to an embodiment may obtain, from an image of another vehicle, vehicle information of the other vehicle. According to an embodiment, the vehicle information may include information such as a vehicle model, year, and accident rate.

Referring to FIG. 4, for example, when it is determined that the front view is cloudy due to rain and fog, 401, and that the road is an unpaved road where the road condition is not good, 402, the electronic device 100 may increase the sensing sensitivity of driving-assistance operation-related sensors including the LIDAR sensor, RADAR sensor, image sensor, and the like.

Accordingly, more precise sensing is possible over a wider measurement range, and a safer driving-assist environment can be realized.

In addition, for example, when it is determined that the ambient illuminance is high (404), and the road condition is good (405), by using an illuminance sensor or the like, the electronic device 100 may lower the sensing sensitivity of a sensor related to a driving-assistance operation.

According to an embodiment, in a relatively safe driving state, by reducing the sensing sensitivity of a sensor, it is possible to prevent the driver's attention from being distracted due to too frequent notifications or warning sounds.

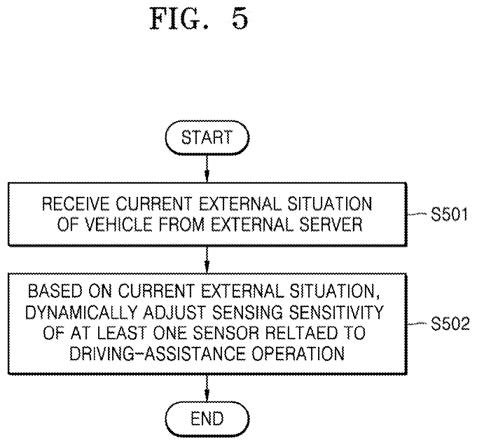

FIG. 5 is a flowchart of an operating method of an electronic device according to an external situation of a vehicle according to another embodiment.

In operation S501 of FIG. 5, the electronic device 100 may receive a current external situation of the vehicle from an external server.

According to an embodiment, the electronic device 100 may receive an external situation, for example, a road condition, weather information, and the like, from an external server through a communicator 160 (see FIG. 12). The electronic device 100 may obtain an external situation related to a current driving state of the vehicle through data linkage with an external server (not shown).

In operation S502 of FIG. 5, the electronic device 100 may dynamically adjust the sensing sensitivity of at least one sensor related to a driving-assistance operation based on the current external situation.

For example, when it is determined that it is a dangerous situation (for example, when the front view is blurred by fog) based on weather information, road conditions, or the like, received from the external server (not shown), the electronic device 100 may increase the sensing sensitivity of at least one sensor associated with driving-assistance operation.

FIG. 5 is for describing an embodiment and is not limited thereto.

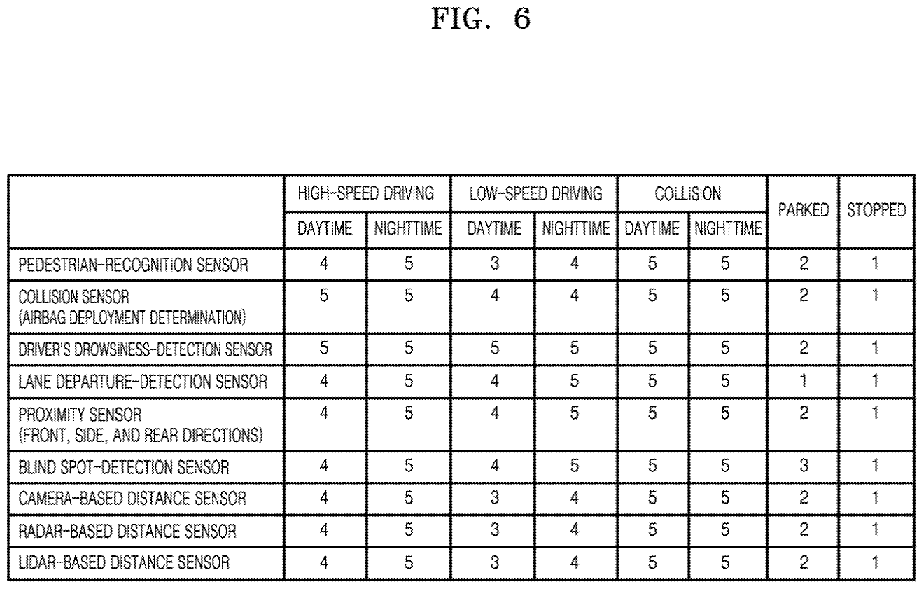

FIG. 6 is a diagram for describing an example of the sensing sensitivity of a sensor according to an embodiment.

FIG. 6 shows an example of adaptively adjusting the sensing sensitivity of the sensor according to the driving state.

For example, when it is determined that the vehicle 1 is driving high-speed in a dark night time, the electronic device 100 may increase the sensing sensitivity of sensors related to driving-assistance operation to the highest level (e.g., Level 5).

In addition, for example, when the danger of collision of the vehicle 1 is detected, the electronic device 100 may increase the sensing sensitivity of sensors related to driving-assistance operation to the highest level (e.g., Level 5).

In addition, for example, when it is determined that the vehicle 1 is stopped, the electronic device 100 may lower the sensing sensitivity of sensors related to driving-assistance operation to the lowest level (e.g., Level 1).

In addition, for example, when it is determined that the vehicle 1 is in low-speed driving during the daytime, the electronic device 100 may adjust the driver's drowsiness detection sensor to the highest level (e.g., Level 5), and adjust the pedestrian recognition sensor, the distance sensor, and the like, to an intermediate level (e.g., Level 3).

FIG. 6 illustrates an embodiment and is not limited thereto.

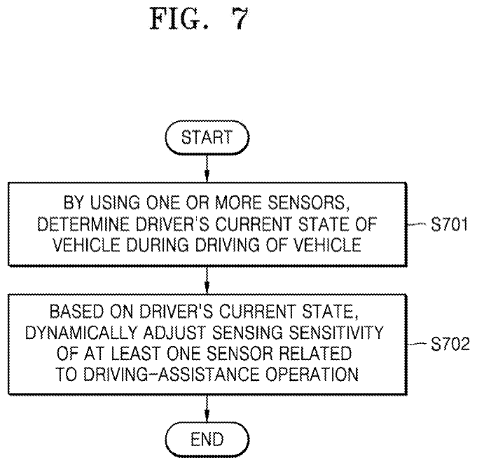

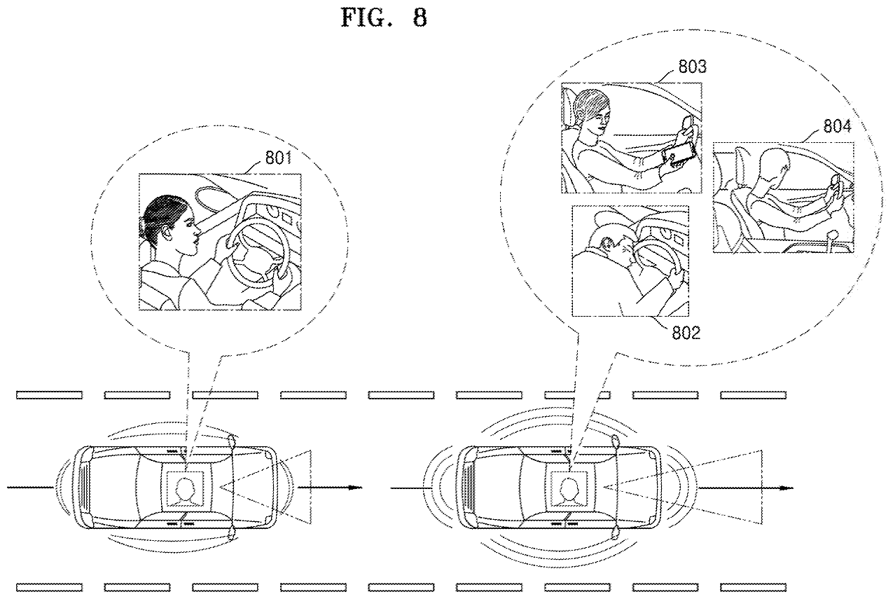

FIG. 7 is a flowchart of an operating method of an electronic device according to a driver's state according to an embodiment. FIG. 8 is a diagram for describing an operating method of an electronic device according to a driver's state according to an embodiment. The flowchart of FIG. 7 will be described with reference to FIG. 8.

In operation S701 of FIG. 7, the electronic device 100 may determine a current state of a driver of a vehicle by using one or more sensors during the driving of the vehicle.

The sensing unit 110 of the electronic device 100 according to an embodiment may detect a state of a driver driving the vehicle 1.

According to an embodiment, the sensing unit 110 including the image sensor 228 may obtain an image of the driver driving the vehicle 1, to thereby detect a state of the driver including at least one of a facial expression, gaze, or behavior of the driver.

For example, the processor 120 may determine that the driver is drowsy through a facial expression of the driver detected through the image sensor 228. For example, the processor 120 of the electronic device 100 may determine that the driver is drowsy when the driver frequently yawns or the number of blinks of the eyes increases.

Further, for example, the sensing unit 110 may detect an action in which the driver does not look forward for more than a few seconds while driving. In addition, for example, the sensing unit 110 may detect a driver's action of operating a smart phone while driving.

In operation S702, the electronic device 100 may dynamically adjust the sensing sensitivity of at least one sensor related to a driving-assistance operation based on the driver's current situation.

Referring to FIG. 8, for example, when it is determined that the driver is the forward gazing state 801, the electronic device 100 may lower the sensing sensitivity of sensors related to driving-assistance operation as compared to a dangerous situation.

In addition, for example, when it is determined that the driver is a drowsy state, 802, that the driver is looking at a smartphone, 803, or that the driver is gazing another direction other than the front, 804 by using an image sensor (e.g., a camera), the electronic device 100 may elevate the sensing sensitivity of sensors related to driving-assistance operation as a dangerous situation.

FIGS. 7 to 8 illustrate an embodiment and are not limited thereto.

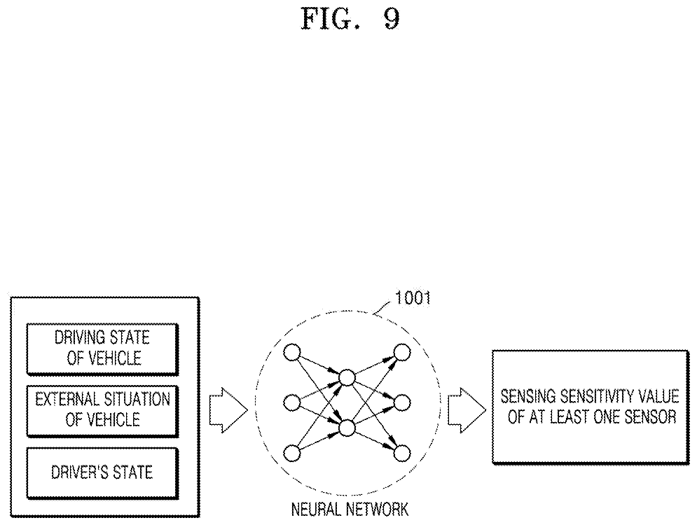

FIG. 9 is a diagram for describing an example of adjusting the sensing sensitivity of a sensor by using a trained model according to an embodiment.

According to an embodiment, the electronic device 100 may determine the sensing sensitivity value of at least one sensor related to a driving-assistance operation based on a current driving state (e.g., high-speed driving, low-speed driving, parking state, and the like) by using a trained model 1001 trained by using an artificial intelligence algorithm.

In addition, the electronic device 100 may determine a sensing sensitivity value of at least one sensor related to a driving-assistance operation based on an external situation (e.g., weather conditions, road conditions, and the like) of the vehicle 1 by using the trained model 1001 trained by using an artificial intelligence algorithm.

In addition, the electronic device 100 may determine a sensing sensitivity value of at least one sensor related to a driving-assistance operation based on the state of the driver of the vehicle 1 (e.g., a drowsiness state, a forward gaze state, and the like) by using the trained model 1001 trained by using an artificial intelligence algorithm.

In addition, the electronic device 100 may determine a sensing sensitivity value of at least one sensor related to a driving-assistance operation based on at least one of a current driving state, an external situation of a vehicle, or a driver's state by using the trained model 1001 trained by using an artificial intelligence algorithm.

According to an embodiment, the electronic device 100 may, by using the trained model 1001, which has been pre-trained, determine a sensor requiring adjustment of sensing sensitivity in the current state among one or more sensors included in the vehicle 1, and determine the extent of adjustment for the sensing sensitivity.

According to an embodiment, the trained model 1001 may be a data recognition model previously trained for a vast amount of data regarding optimal sensing values for inducing safe driving in examples of the driving states, surroundings, and driver's states of various vehicles.

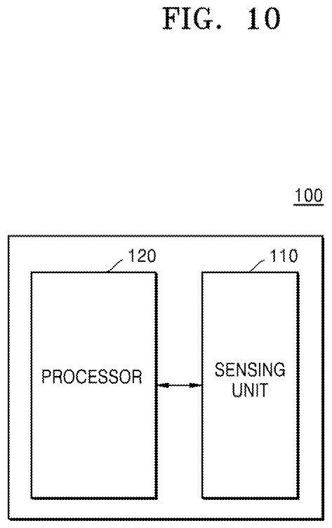

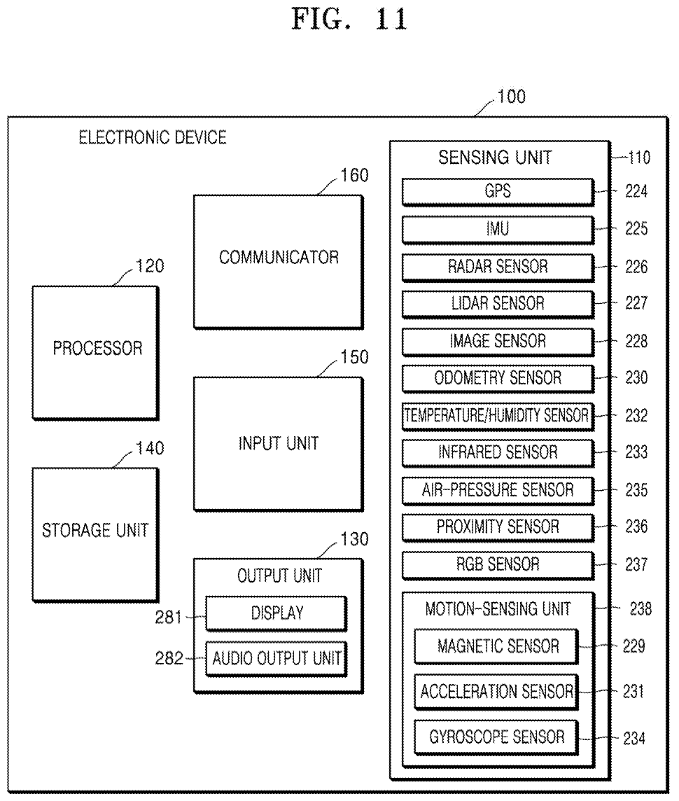

According to an embodiment, the processor 120 (see FIGS. 10 and 11) of the electronic device 100 may use a data recognition model based on a neural network such as a deep neural network (DNN) or a recurrent neural network (RNN).

According to an embodiment, the processor 120 may update the data recognition model as a risk situation is trained. In addition, the processor 120 may update the data recognition model as a dangerous situation determined based on a plurality of situations detected at a near time is trained.

FIG. 9 illustrates an embodiment and is not limited thereto.

FIG. 10 is a block diagram of an electronic device according to an embodiment.

The electronic device 100 may include a sensing unit 110 and a processor 120, according to an embodiment. In the electronic device 100 illustrated in FIG. 11, only components related to the embodiment are illustrated. Therefore, a person having ordinary knowledge in the art related to this embodiment may understand that other general-purpose components may be further included in addition to the components illustrated in FIG. 11.

According to an embodiment, the sensing unit 110 may detect a driving condition of the vehicle 1 during the driving of the vehicle 1. In addition, the sensing unit 110 may detect an external situation around the vehicle 1. In addition, the sensing unit 110 may detect a driver's state in the vehicle 1.

In addition, according to an embodiment, the sensing unit 110 may detect movement of the vehicle 1 required for driving-assistance or autonomous control of the vehicle 1, the driving state of other vehicles in the vicinity, information about the surrounding environment, and the like.

The sensing unit 110 may include multiple sensors. For example, the sensing unit 110 may include, but is not limited to, a distance sensor such as a LIDAR sensor and a RADAR sensor, and an image sensor such as a camera.

In addition, the sensing unit 110 may include one or more actuators configured to correct the position and/or orientation of multiple sensors, so that objects located in each of the front, rear, and side directions of the vehicle 1 may be sensed.

In addition, the sensing unit 110 may sense the shape of an object located nearby and the shape of a lane by using an image sensor.

According to an embodiment, the processor 120 may include at least one processor.

According to an embodiment, the processor 120 may determine the current driving state of the vehicle 1 by using one or more sensors during the driving of the vehicle.

Further, the processor 120 may dynamically adjust sensing sensitivity of at least one sensor related to a driving-assistance operation among the one or more sensors based on the determined current driving state.

In addition, the processor 120 may control the driving-assistance operation of the vehicle by using at least one sensor related to the driving-assistance operation.

In addition, the processor 120 may determine, based on the determined current driving state, a sensing sensitivity value of at least one sensor related to a driving-assistance operation by using a trained model trained by using an artificial intelligence algorithm.

In addition, the processor 120 may adjust a measurement range of at least one sensor related to a driving-assistance operation based on the determined current driving state.

In addition, the processor 120 may adjust the sensing sensitivity of at least one sensor determined based on the risk of the determined current driving state.

In addition, the processor 120 may determine the current external situation of the vehicle by using one or more sensors during the driving of the vehicle, and based on the determined current external situation, to dynamically adjust the sensing sensitivity of at least one sensor related to a driving-assistance operation among the one or more sensors.

Further, the processor 120 may receive a current external situation of the vehicle from an external server through the communicator 160.

In addition, the processor 120 may determine, by using one or more sensors, a current state of the driver during the driving of the vehicle, and based on the determined driver's current state, to dynamically adjust the sensing sensitivity of at least one sensor related to a driving-assistance operation among the one or more sensors.

FIG. 11 is a block diagram of an electronic device according to another embodiment.

The electronic device 100 may include the sensing unit 110, a processor 120, an output unit 130, a storage unit 140, an input unit 150, and the communicator 160.

The sensing unit 110 may include a number of sensors configured to sense information about the surrounding environment in which the vehicle 1 is located, and may include one or more actuators configured to modify the position and/or orientation of the sensors. For example, the sensing unit 110 may include the GPS 224, the IMU 225, the RADAR sensor 226, the LIDAR sensor 227, the image sensor 228, and the odometry sensor 230. Further, the sensing unit 110 may include at least one of the temperature/humidity sensor 232, the infrared sensor 233, the barometric pressure sensor 235, the proximity sensor 236, or the RGB sensor (illuminance sensor) 237, but is not limited thereto. The function of each sensor can be intuitively deduced by a person of skill in the art from the name, so detailed descriptions are not omitted here.

In addition, the sensing unit 110 may include a motion-sensing unit 238 capable of sensing the motion of the vehicle 1. The motion-sensing unit 238 may include the magnetic sensor 229, the acceleration sensor 231, and the gyroscope sensor 234.

The GPS 224 may be a sensor configured to estimate the geographical location of the vehicle 1. That is, the GPS 224 may include a transceiver configured to estimate a location of the vehicle 1 relative to the Earth.

The IMU 225 may be a combination of sensors configured to sense changes in position and orientation of the vehicle 1 based on inertial acceleration. For example, a combination of sensors may include accelerometers and gyroscopes.

The RADAR sensor 226 may be a sensor configured to detect objects in an environment in which the vehicle 1 is located, by using a wireless signal. Further, the RADAR sensor 226 may detect the speed and/or direction of objects.

The LIDAR sensor 227 may be a sensor configured to detect objects in the environment where the vehicle 1 is located, by using a laser. More specifically, the LIDAR sensor 227 may include a laser light source configured to emit a laser and/or a laser scanner, and a detector configured to detect reflection of the laser. The LIDAR sensor 227 may operate in a coherent (e.g., using heterodyne detection) or incoherent detection mode.

The image sensor 228 may be a still video camera or video camera configured to record the environment outside the vehicle 1. For example, the image sensor 228 may include multiple cameras, and multiple cameras may be placed at multiple locations on the inside and outside of the vehicle 1.

The odometry sensor 230 may estimate the position of the vehicle 1 and measure the moving distance. For example, the odometry sensor 230 may measure a position change value of the vehicle 1 by using the number of revolutions of wheels of the vehicle 1.

The storage unit 140 may include a magnetic disk drive, an optical disk drive, and flash memory. Alternatively, the storage unit 140 may be a portable USB data-storage device. The storage unit 140 may store system software for executing embodiments related to the disclosure. The system software for executing the embodiments related to the disclosure may be stored in a portable storage medium.

The communicator 160 may include at least one antenna for wireless communication with other devices. For example, the communicator 160 may be used to communicate with a cellular network or other wireless protocols and systems wirelessly via Wi-Fi or Bluetooth. The communicator 160 controlled by the processor 120 may transmit and receive wireless signals. For example, the processor 120 may execute a program included in the storage unit 140 in order for the communicator 160 to transmit and receive wireless signals to and from a cellular network.

The input unit 150 means a means for inputting data for controlling the vehicle 1. For example, the input unit 150 may include a key pad, dome switch, and touch pad (contact capacitive type, pressure resistive type, infrared detection type, surface ultrasonic conduction type, integral tension measurement type, Piezo effect type, and the like), a jog wheel, a jog switch, and the like, but is not limited thereto. In addition, the input unit 150 may include a microphone, and the microphone may receive audio (e.g., voice commands) from a passenger of the vehicle 1.

The output unit 130 may output an audio signal or a video signal, and an output device 280 may include a display 281 and an audio output unit 282.

The display 281 may include at least one of a liquid crystal display, a thin film transistor-liquid crystal display, an organic light-emitting diode, a flexible display, a 3D display, or an electrophoretic display. Depending on the implementation form of the output unit 130, the output unit 130 may include two or more displays 281.

The audio output unit 282 may output audio data received from the communicator 160 or stored in the storage unit 140. In addition, the audio output unit 282 may include a speaker, a buzzer, and the like.

The input unit 150 and the output unit 130 may include a network interface, and may be implemented as a touch screen.

The processor 120 may overall control the sensing unit 110, the communicator 160, the input unit 150, the storage unit 140, and the output unit 130 by executing programs stored in the storage unit 140.

FIG. 12 is a block diagram of a vehicle according to an embodiment.

The vehicle 1 may include the electronic device 100 and a driving device 200 according to an embodiment. The vehicle 1 shown in FIG. 12 shows only components related to this embodiment. Therefore, a person having ordinary knowledge in the art related to this embodiment may understand that other general-purpose components may be further included in addition to the components illustrated in FIG. 12.

The electronic device 100 may include a sensing unit 110 and a processor 120.

The description of the sensing unit 110 and the processor 120 has been provided with reference to FIGS. 10 and 11, and thus will be omitted.

The driving device 200 may include a brake unit 221, a steering unit 222, and a throttle 223.

The steering unit 222 may be a combination of mechanisms configured to adjust the direction of the vehicle 1.

The throttle 223 may be a combination of mechanisms configured to control the speed of the vehicle 1 by controlling the operating speed of an engine/motor 211. In addition, the throttle 223 may control a throttle opening amount to control the amount of gas mixture in the fuel air flowing into the engine/motor 211, and to control the throttle opening amount to control power and thrust.

The brake unit 221 may be a combination of mechanisms configured to decelerate the vehicle 1. For example, the brake unit 221 may use friction to reduce the speed of a wheel/tire 214.

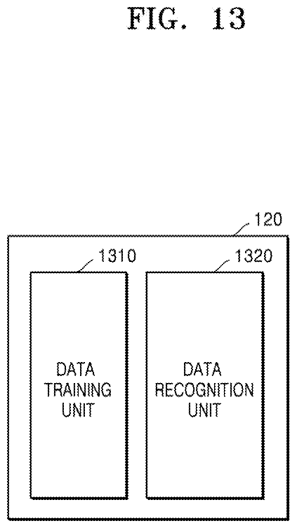

FIG. 13 is a block diagram of a processor according to an embodiment.

Referring to FIG. 13, the processor 120 according to some embodiments may include a data training unit 1310 and a data recognition unit 1320.

The data training unit 1310 may learn the criteria for determining a situation. The data training unit 1310 may learn criteria for what data is to be used to determine a certain situation and how to determine the situation by using the data. The data training unit 1310 may obtain data to be used for training, and apply the obtained data to a data recognition model to be described below, thereby learning criteria for situation determination.

The data recognition unit 1320 may determine a situation based on data. The data recognition unit 1320 may recognize a situation from preset data by using a trained data recognition model. The data recognition unit 1320 may obtain preset data according to a preset criterion by training, and to use a data recognition model by using the obtained data as an input value, thereby determining a preset situation based on the preset data. Further, a result value output by the data recognition model by using the obtained data as an input value may be used to refine the data recognition model.

At least one of the data training unit 1310 or the data recognition unit 1320 may be manufactured in the form of at least one hardware chip and mounted on an electronic device. For example, at least one of the data training unit 1310 or the data recognition unit 1320 may be manufactured in the form of a dedicated hardware chip for artificial intelligence (AI), or an existing general-purpose processor (for example, a CPU or application processor), or may be manufactured as part of a graphics-only processor (for example, a GPU) and mounted on the various electronic devices described above.

In this case, the data training unit 1310 and the data recognition unit 1320 may be mounted on one electronic device, or may be mounted on separate electronic devices, respectively. For example, one of the data training unit 1310 and the data recognition unit 1320 may be included in an electronic device, and the other may be included in a server. Further, the data training unit 1310 and the data recognition unit 1320 may provide model information constructed by the data training unit 1310 to the data recognition unit 1320 through wired or wireless communication, and data input to the data recognition unit 1320 may be provided to the data training unit 1310 as additional training data.

Meanwhile, at least one of the data training unit 1310 or the data recognition unit 1320 may be implemented as a software module. When at least one of the data training unit 1310 or the data recognition unit 1320 is implemented as a software module (or a program module including an instruction), the software module may be stored in non-transitory computer-readable media. In addition, in this case, at least one software module may be provided by an operating system (OS) or may be provided by a preset application. Alternatively, some of the at least one software module may be provided by an OS, and the other may be provided by a preset application.

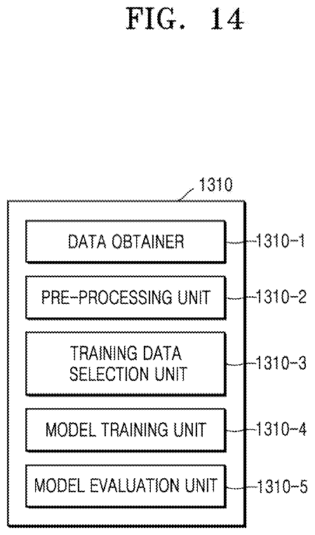

FIG. 14 is a block diagram of a data training unit according to an embodiment.

Referring to FIG. 14, the data training unit 1310 according to some embodiments may include a data obtainer 1310-1, a pre-processing unit 1310-2, a training data selection unit 1310-3, a model training unit 1310-4, and a model evaluation unit 1310-5.

The data obtainer 1310-1 may obtain data necessary for situation determination. The data obtainer 1310-1 may obtain data necessary for training for situation determination.

In addition, the data obtainer 1310-1 may receive status data from a server.

For example, the data obtainer 1310-1 may receive a surrounding image of the vehicle 1. The surrounding image may include a plurality of images (or frames). For example, the data obtainer 1310-1 may receive a video through a camera of an electronic device including a data training unit 1310, or an external camera (e.g., CCTV or black box) capable of communicating with an electronic device including a data training unit 1310. Here, the camera may include one or more image sensors (e.g., front sensor or rear sensor), a lens, an image signal processor (ISP), or a flash (e.g., LED or xenon lamp, and the like.

Further, for example, the data obtainer 1310-1 may obtain driving states, vehicle information, and the like of other vehicles. For example, the data obtainer 1310-1 may receive data through an input device (e.g., microphone, camera, or sensor) of an electronic device. Alternatively, the data obtainer 1310-1 may obtain data through an external device communicating with an electronic device.

The pre-processing unit 1310-2 may preprocess the obtained data such that the obtained data may be used for training for situation determination. The pre-processing unit 1310-2 may process the obtained data in a preset format such that the model training unit 1310-4, which will be described below, is able to use the obtained data for training for situation determination. For example, the pre-processing unit 1310-2 may, based on a common region included in each of a plurality of images (or frames) included in at least a part of an input video, overlap at least a part of the plurality of images and generate a single composite image. In this case, a plurality of composite images may be generated from one video. The common region may be a region that includes the same or similar common object (e.g., an object, a plant or animal, or a person) in each of the plurality of images. Alternatively, the common region may be a region in which colors, shades, RGB values, or CMYK values are the same or similar in each of the plurality of images.

The training data selection unit 1310-3 may select data necessary for training from the pre-processed data. The selected data may be provided to the model training unit 1310-4. The training data selection unit 1310-3 may select data necessary for training from the pre-processed data according to a preset criterion for situation determination. In addition, the training data selection unit 1310-3 may select data according to a preset criterion by training by the model training unit 1310-4, which will be described below.

The model training unit 1310-4 may learn, based on training data, criteria for how to determine a situation. In addition, the model training unit 1310-4 may also learn criteria as to what training data should be used for situation determination.

According to an embodiment, the model training unit 1310-4 may learn criteria for which dangerous situation is to be determined, based on status data including a vehicle driving state, a driver's state, and a state of another vehicle.

In addition, the model training unit 1310-4 may train a data recognition model used for situation determination by using training data. In this case, the data recognition model may be a pre-built model. For example, the data recognition model may be a model pre-built by receiving basic training data (e.g., a sample image).

The data recognition model may be constructed in consideration of the application field of the recognition model, the purpose of training, or the computer performance of a device. The data recognition model may be, for example, a model based on a neural network. For example, a model such as a deep neural network (DNN), a recurrent neural network (RNN), or a bidirectional recurrent deep neural network (BRDNN) may be used as a data recognition model, but is not limited thereto.

According to various embodiments, when a plurality of pre-built data recognition models exist, the model training unit 1310-4 may determine a data recognition model in which input training data is of high relevance to basic training data as a data recognition model to be trained. In this case, the basic training data may be pre-classified for each type of data, and the data recognition model may be pre-built for each type of data. For example, the basic training data may be pre-classified based on various criteria such as the region where training data is generated, the time when training data is generated, the size of training data, the genre of training data, the generator of training data, and the type of object in training data.

Further, the model training unit 1310-4 may train a data recognition model by using, for example, a training algorithm including an error back-propagation algorithm or a gradient descent algorithm.

In addition, the model training unit 1310-4 may train the data recognition model, for example, through supervised learning using training data as an input value. In addition, the model training unit 1310-4 may train a data recognition model, for example, through unsupervised learning to discover criteria for situation determination by self-training based on the type of data necessary for situation determination without much guidance. In addition, the model training unit 1310-4 may train a data recognition model, for example, through reinforcement learning using feedback on whether a result of situation determination according to training is correct.

In addition, when the data recognition model is trained, the model training unit 1310-4 may store the trained data recognition model. In this case, the model training unit 1310-4 may store the trained data recognition model in a memory of an electronic device including the data recognition unit 1320. Alternatively, the model training unit 1310-4 may store the trained data recognition model in a memory of an electronic device including the data recognition unit 1320 to be described below. Alternatively, the model training unit 1310-4 may store the trained data recognition model in the memory of a server connected to an electronic device via a wired or wireless network.

In this case, the memory, in which the trained data recognition model is stored, may store, for example, commands or data related to at least one other component of the electronic device together. In addition, the memory may store software and/or programs. The program may include, for example, a kernel, middleware, application programming interface (API), and/or application program (or “application”).

The model evaluation unit 1310-5 may input evaluation data into a data recognition model, and when a recognition result output from the evaluation data does not satisfy a preset criterion, to cause the model training unit 1310-4 to train again. In this case, the evaluation data may be preset data for evaluating the data recognition model.

For example, among the recognition results of a trained data recognition model for the evaluation data, when the number or percentage of evaluation data in which the recognition result is not accurate exceeds a preset threshold, the model evaluation unit 1310-5 may configured to evaluate that a preset criterion is not satisfied. For example, in a case where a preset criterion is defined as a ratio of 2%, when the trained data recognition model outputs an incorrect recognition result for more than 20 evaluation data out of a total of 1000 evaluation data, the model evaluation unit 1310-5 may determine that the trained data recognition model is not appropriate.

On the other hand, when there are a plurality of trained data recognition models, the model evaluation unit 1310-5 may evaluate whether or not a preset criterion is satisfied for each trained video recognition model, and to determine a model satisfying the preset criterion as the final data recognition model. In this case, when there are a plurality of models satisfying the preset criterion, the model evaluation unit 1310-5 may determine any one or a certain number of models preset in order of highest evaluation score as the final data recognition model.

Meanwhile, at least one of the data obtainer 1310-1, the pre-processing unit 1310-2, the training data selection unit 1310-3, the model training unit 1310-4, or the model evaluation unit 1310-5 in the data training unit 1310 may be manufactured in the form of at least one hardware chip and mounted on an electronic device. For example, at least one of the data obtainer 1310-1, the pre-processing unit 1310-2, the training data selection unit 1310-3, the model training unit 1310-4, or the model evaluation unit 1310-5 may be manufactured in the form of a dedicated hardware chip for artificial intelligence (AI), or may be manufactured as part of an existing general-purpose processor (e.g., CPU or application processor) or graphics-only processor (e.g., GPU) and mounted on the various electronic devices described above.

In addition, the data obtainer 1310-1, the pre-processing unit 1310-2, the training data selection unit 1310-3, the model training unit 1310-4, and the model evaluation unit 1310-5 may be mounted in one electronic device or may be mounted on separate electronic devices, respectively. For example, some of the data obtainer 1310-1, the pre-processing unit 1310-2, the training data selection unit 1310-3, the model training unit 1310-4, and the model evaluation unit 1310-5 may be included in an electronic device, and the other part may be included in a server.

In addition, at least one of the data obtainer 1310-1, the pre-processing unit 1310-2, the training data selection unit 1310-3, the model training unit 1310-4, or the model evaluation unit 1310-5 may be implemented by a software module. When at least one of the data obtainer 1310-1, the pre-processing unit 1310-2, the training data selection unit 1310-3, the model training unit 1310-4, or the model evaluation unit 1310-5 is implemented as a software module (or a program module including an instruction), the software module may be stored in non-transitory computer-readable media. In addition, in this case, at least one software module may be provided by an OS or may be provided by a preset application. Alternatively, some of the at least one software module may be provided by an OS, and the other may be provided by a preset application.

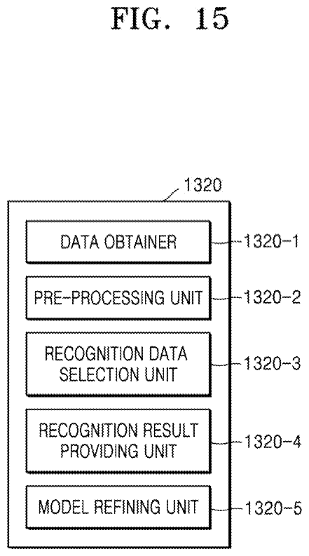

FIG. 15 is a block diagram of a data recognition unit according to an embodiment.

Referring to FIG. 15, a data recognition unit 1320 according to some embodiments may include a data obtainer 1320-1, a pre-processing unit 1320-2, a recognition data selection unit 1320-3, a recognition result providing unit 1320-4, and a model refining unit 1320-5.

The data obtainer 1320-1 may obtain data necessary for situation determination, and the pre-processing unit 1320-2 may preprocess the obtained data such that the obtained data may be used for situation determination. The pre-processing unit 1320-2 may process the obtained data in a preset format such that the recognition result providing unit 1320-4, which will be described below, may use the obtained data for situation determination.

The recognition data selection unit 1320-3 may select data necessary for situation determination from the pre-processed data. The selected data may be provided to the recognition result providing unit 1320-4. The recognition data selection unit 1320-3 may select some or all of the pre-processed data according to preset criteria for situation determination. In addition, the recognition data selection unit 1320-3 may select data according to a preset criterion by training by the model training unit 1310-4, which will be described below.

The recognition result providing unit 1320-4 may determine a situation by applying the selected data to a data recognition model. The recognition result providing unit 1320-4 may provide recognition results according to the purpose of recognizing data. The recognition result providing unit 1320-4 may apply data selected by the recognition data selection unit 1320-3 to the data recognition model by using the selected data as an input value. In addition, the recognition result may be determined by a data recognition model.

The model refining unit 1320-5 may refine the data recognition model based on evaluation of recognition results provided by the recognition result providing unit 1320-4. For example, the model refining unit 1320-5 may provide the recognition result provided by the recognition result providing unit 1320-4 to the model training unit 1310-4, so that the model training unit 1310-4 refines the data recognition model.

Meanwhile, at least one of the data obtainer 1320-1, the pre-processing unit 1320-2, the recognition data selection unit 1320-3, the recognition result providing unit 1320-4, or the model refining unit 1320-5 in the data recognition unit 1320 may be manufactured in the form of at least one hardware chip and mounted on an electronic device. For example, at least one of the data obtainer 1320-1, the pre-processing unit 1320-2, the recognition data selection unit 1320-3, the recognition result providing unit 1320-4, or the model refining unit 1320-5 may be manufactured in the form of a dedicated hardware chip for artificial intelligence (AI), or may be manufactured as part of an existing general-purpose processor (e.g., CPU or application processor) or graphics-only processor (e.g., GPU) and mounted on the various electronic devices described above.

In addition, the data obtainer 1320-1, the pre-processing unit 1320-2, the recognition data selection unit 1320-3, the recognition result providing unit 1320-4, and the model refining unit 1320-5 may be mounted on one electronic device, or may be mounted on separate electronic devices, respectively. For example, some of the data obtainer 1320-1, the pre-processing unit 1320-2, the recognition data selection unit 1320-3, the recognition result providing unit 1320-4, and the model refining unit 1320-5 may be included in an electronic device, and the rest may be included in a server.

In addition, at least one of the data obtainer 1320-1, the pre-processing unit 1320-2, the recognition data selection unit 1320-3, the recognition result providing unit 1320-4, or the model refining unit 1320-5 may be implemented by a software module. When at least one of the data obtainer 1320-1, the pre-processing unit 1320-2, the recognition data selection unit 1320-3, the recognition result providing unit 1320-4, or the model refining unit 1320-5 is implemented as a software module (or a program module including an instruction), the software module may be stored in non-transitory computer-readable media. In addition, in this case, at least one software module may be provided by an OS or may be provided by a preset application. Alternatively, some of the at least one software module may be provided by an OS, and the other may be provided by a preset application.

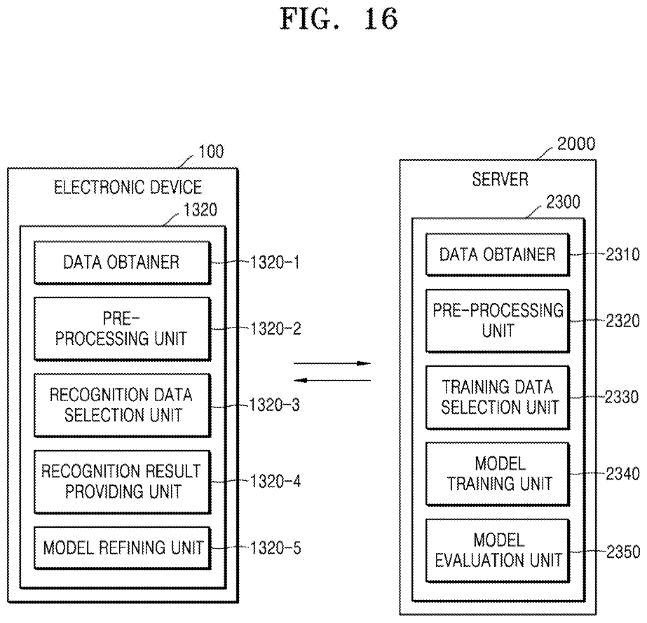

FIG. 16 is a diagram illustrating an example of training and recognizing data by interworking between an electronic device and a server according to an embodiment.

Referring to FIG. 16, a server 2000 may learn a criterion for determining a situation, and the electronic device 100 may determine a situation based on a result of training by the server 2000.

In this case, a model training unit 2340 of the server 2000 may perform the function of the data training unit 1310 shown in FIG. 15. The model training unit 2340 of the server 2000 may learn the criteria for what data to use to determine a preset situation and how to determine the situation by using the data. The model training unit 2340 may obtain data to be used for training, and to apply the obtained data to a data recognition model to be described below, thereby learning criteria for situation determination.

In addition, the recognition result providing unit 1320-4 of the electronic device 100 may determine the situation by applying the data selected by the recognition data selection unit 1320-3 to the data recognition model generated by the server 2000. For example, the recognition result providing unit 1320-4 may transmit data selected by the recognition data selection unit 1320-3 to the server 2000, and the server 2000 may request situation determination by applying the data selected by the recognition data selection unit 1320-3 to a recognition model. In addition, the recognition result providing unit 1320-4 may receive information about the situation determined by the server 2000 from the server 2000.

For example, the electronic device 100 may transmit a driving state, a driver's state, and an external situation of the vehicle 1, and a driving state of the surrounding vehicles, etc. to the server 2000, and the server 2000 may apply them to a data recognition model and request a sensing sensitivity value of at least one sensor of the vehicle 1 to be determined.

In addition, the electronic device 100 may receive a sensing sensitivity value of at least one sensor of the vehicle 1 determined by the server 2000 from the server 2000.

Alternatively, the recognition result providing unit 1320-4 of the electronic device 100 may receive a recognition model generated by the server 2000 from the server 2000, and to determine a situation by using the received recognition model. In this case, the recognition result providing unit 1320-4 of the electronic device 100 may determine the situation by applying data selected by the recognition data selection unit 1320-3 to a data recognition model received from the server 2000.

For example, the electronic device 100 may determine a sensing sensitivity value of at least one sensor of the vehicle 1 by applying the driving state, the driver's state, and the external situation of the vehicle 1, and the driving state of surrounding vehicles, etc. to the data recognition model received from the server 2000.

Meanwhile, the above-described embodiment may be recorded as a program being executable on a computer and may be implemented in a general-purpose digital computer that executes the program by using a computer-readable medium. In addition, the structure of the data used in the above-described embodiment may be recorded on a computer-readable medium through various means. Further, the above-described embodiment may be implemented in the form of a recording medium including instructions executable by a computer, such as program modules executed by a computer. For example, methods implemented by a software module or algorithm may be stored in a computer-readable recording medium as computer readable and executable codes or program instructions.

Computer-readable media may be any recording media that can be accessed by a computer, and may include volatile and non-volatile media, and removable and non-removable media. Computer-readable media may include, but is not limited to, magnetic storage media, such as ROMs, floppy disks, hard disks, and the like, and optical storage media such as storage media including CD-ROMs, DVDs, and the like. In addition, computer-readable media may include computer storage media and communication media.

In addition, a plurality of computer-readable recording media may be distributed over network-coupled computer systems, and data stored in the distributed recording media, for example, program instructions and codes, may be executed by at least one computer.

The specific implementations described in this disclosure are only exemplary, and do not limit the scope of the disclosure in any way. For brevity of the specification, descriptions of related-art electronic configurations, control systems, software, and other functional aspects of the systems may be omitted.

The foregoing descriptions of the disclosure is for illustration only, and those of skill in the art to which the disclosure pertains will understand that the disclosure may be easily modified to other specific forms without changing the technical spirit or essential features of the disclosure. Therefore, it should be understood that the embodiments described above are illustrative in all respects and not restrictive. For example, each component described as a single type may be implemented in a distributed manner, and similarly, components described as distributed may be implemented in a combined form.

The use of all examples or exemplary terms in the disclosure, e.g., “etc.”, is merely for describing the disclosure in detail, and the scope of the disclosure is due to the above examples or exemplary terms unless it is limited by the claims.

In addition, unless specifically mentioned, such as “essential”, “importantly”, and the like, the components described in the disclosure may not be necessary components for the implementation of the disclosure.

Those of ordinary skill in the art to which the embodiments of the disclosure pertain will understand that it may be implemented in a modified form without departing from the essential characteristics of the above description.

Because the disclosure may apply various conversions and may include various embodiments, it should be understood that the disclosure is not limited by the specific embodiments described in the specification, and that all conversions and equivalents or alternatives included in the spirit and scope of the disclosure are included in the disclosure. Therefore, the disclosed embodiments should be understood from an explanatory point of view rather than a restrictive point of view.

The scope of the disclosure is indicated by the claims rather than the detailed descriptions of the disclosure, and all changes or modifications derived from the meaning and scope of the claims and equivalent concepts should be interpreted as being included in the scope of the disclosure.

The terms “ . . . unit”, “module”, and the like described herein mean a unit that processes at least one function or operation, and may be implemented by hardware or software, or a combination of hardware and software.

“Units” and “modules” are stored in an addressable storage medium and may be implemented by a program executable by a processor.

For example, “unit”, “module” may be implemented by components such as software components, object-oriented software components, class components, and task components, and by processes, functions, attributes, and procedures, subroutines, segments of program code, drivers, firmware, microcode, circuitry, data, database, data structures, tables, arrays, and variables.

In the specification, the description that “A may include one of a1, a2, and a3” has a broad meaning that an exemplary element that may be included in the element A is a1, a2, or a3.

The above description does not necessarily limit the elements that can be included in the element A to a1, a2, or a3. Therefore, it should be noted that elements that may be included in A are not interpreted exclusively in the sense that other elements not exemplified other than a1, a2, and a3 are excluded.

In addition, the above description means that A may include a1, a2, or a3. The above description does not necessarily mean that elements included in A are selectively determined within a preset set. It should be noted that, for example, the above description is not to be construed as limiting that a1, a2, or a3 selected from the set including a1, a2, and a3 constitute component A.

1. An electronic device for assisting driving of a vehicle, the electronic device comprising:
one or more sensors;
a memory storing one or more instructions; and
a processor configured to execute the one or more instructions stored in the memory,
wherein the processor is configured to, by executing the one or more instructions:
determine a current driving state of the vehicle by using the one or more sensors during the driving of the vehicle;
based on the determined current driving state, dynamically adjust a sensing sensitivity of at least one sensor related to a driving-assistance operation, from among the one or more sensors; and
control the driving-assistance operation of the vehicle by using the at least one sensor related to the driving-assistance operation.

2. The electronic device of claim 1, wherein the processor is configured to, by executing the one or more instructions, determine, based on the determined current driving state, a sensing sensitivity value of the at least one sensor related to the driving-assistance operation by using a trained model trained by using an artificial intelligence algorithm.

3. The electronic device of claim 1, wherein the processor is configured to, by executing the one or more instructions, adjust, based on the determined current driving state, a measurement range of the at least one sensor related to the driving-assistance operation.

4. The electronic device of claim 1, wherein the processor is configured to, by executing the one or more instructions, adjust, based on a risk of the determined current driving state, the sensing sensitivity of the at least one sensor.

5. The electronic device of claim 1, wherein the processor is configured to, by executing the one or more instructions:
determine a current external situation of the vehicle by using the one or more sensors during the driving of the vehicle; and
dynamically adjust, based on the determined current external situation, a sensing sensitivity of the at least one sensor related to the driving-assistance operation, from among the one or more sensors.

6. The electronic device of claim 5, wherein the current external situation of the vehicle comprises at least one of a road condition in which the vehicle is driven or a weather condition around the vehicle.

7. The electronic device of claim 5, further comprising:
a communicator,
wherein the processor is configured to, by executing the one or more instructions, receive the current external situation of the vehicle from an external server through the communicator.

8. The electronic device of claim 1, wherein the processor is configured to, by executing the one or more instructions:
determine, by using the one or more sensors, a current state of a driver of the vehicle during the driving of the vehicle; and
dynamically adjust, based on the determined current state of the driver, the sensing sensitivity of the at least one sensor related to the driving-assistance operation, from among the one or more sensors.

9. The electronic device of claim 8, the state of the driver comprises at least one of a drowsy state or a driving control state of the driver driving the vehicle.

10. An operating method of an electronic device for assisting driving of a vehicle, the operating method comprising:
determining a current driving state of the vehicle by using one or more sensors during the driving of the vehicle;
dynamically adjusting, based on the determined current driving state, a sensing sensitivity of at least one sensor related to a driving-assistance operation, from among the one or more sensors; and
controlling a driving-assistance operation of the vehicle by using the at least one sensor related to the driving-assistance operation.

11. The operating method of claim 10, further comprising:
determining, based on the determined current driving state, a sensing sensitivity value of the at least one sensor related to the driving-assistance operation by using a trained model trained by using an artificial intelligence algorithm.

12. The operating method of claim 10, further comprising:
adjusting, based on the determined current driving state, a measurement range of the at least one sensor related to the driving-assistance operation.

13. The operating method of claim 10, further comprising:
adjusting, based on a risk of the determined current driving state, the sensing sensitivity of the at least one sensor.

14. The operating method of claim 10, comprising:
determining a current external situation of the vehicle by using the one or more sensors during the driving of the vehicle; and
dynamically adjusting, based on the determined current external situation, a sensing sensitivity of the at least one sensor related to the driving-assistance operation, from among the one or more sensors.

15. A computer-readable recording medium having recorded thereon a program for executing the method of claim 10 on a computer.
